(19) United States
(12) Patent Application Publication
(10) Pub. No.: US 2025/0348871 A1
(43) Pub. Date: Nov. 13, 2025

(54) BLOCKCHAIN-BASED MESSAGE JOURNALING

(71) Applicant: nChain Licensing AG, Zug (CH)

(72) Inventors: Liuxuan PAN, London (GB); Katharine MOLLOY, London (GB); Craig Steven WRIGHT, London (GB)

(21) Appl. No.: 18/867,390

(22) PCT Filed: May 18, 2023
(86) PCT No.: PCT/EP2023/063433

§ 371 Date: Nov. 19, 2024

(30) Foreign Application Priority Data
May 25, 2022 (GB) 2207641.8

(51) Int. Cl. G06Q 20/38

(52) U.S. Cl. CPC G06Q 20/389; G06Q 20/3827

(57) ABSTRACT

A computer-implemented method of journaling messages sent to and/or from a first party, wherein the method comprises: determining a first message to be journaled, wherein the first message is sent to or from the first party; generating a first journaled message, wherein the first journaled message comprises a copy of the first message; storing the first journaled message and/or an encrypted version of the first journaled message at a storage location; causing a first blockchain transaction to be sent to a blockchain network to be recorded on a blockchain, wherein the first blockchain transaction comprises a first hash generated by hashing at least the first journaled message.

### CROSS REFERENCE TO RELATED APPLICATIONS

This application is the U.S. National Stage of International Application No. PCT/EP2023/063433 filed on May 18, 2023, which claims the benefit of United Kingdom Patent Application No. 2207641.8, filed on May 25, 2022, the contents of which are incorporated herein by reference in their entireties.

### TECHNICAL FIELD

The present disclosure relates to a method of journaling (i.e. archiving) messages using a blockchain.

BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

There are legal regulations that require enterprises to journal (i.e archive) messages, including emails and other electronic messages, when they are in transit. For example, it is important for banking and financial institutions to journal various messages for auditing, review, litigation, and compliance purposes. Similarly, in the retail sector, it is important to journal emails or messages between staff and customers for sale of goods.

Existing solutions typically rely on cloud storage servers to achieve the scalability and integrity required of journaled messages. However, enterprises that makes use of journaling services need to trust the cloud-based server that is responsible for the integrity of journaled messages. Subsequently, the integrity feature of the cloud-based journaling system faces the challenge of trust. A problem arises in that it is difficult to prove that the journaled messages have not been tampered with by, for example, administrators, the cloud service providers, or otherwise.

There is therefore a need to be able to prove the integrity of journaled messages.

According to one aspect disclosed herein, there is provided a computer-implemented method of journaling messages sent to and/or from a first party, wherein the method comprises: determining a first message to be journaled, wherein the first message is sent to or from the first party; generating a first journaled message, wherein the first journaled message comprises a copy of the first message; storing the first journaled message and/or an encrypted version of the first journaled message at a storage location; causing a first blockchain transaction to be sent to a blockchain network to be recorded on a blockchain, wherein the first blockchain transaction comprises a first hash generated by hashing at least the first journaled message.

The present disclosure describes a blockchain-based journaling solution that makes use of the tamper-resistant nature of the blockchain to maintain the integrity of journaled (i.e. archived) messages. The solution is able to seamlessly integrate with existing journaling systems without changing their fundamental architecture.

A journaling service is configured to detect when a message sent to or from a party (e.g. a user's email account) is to be journaled (i.e. archived) for later access. The journaling service generates a copy of the message. The journaled message may comprise other data in addition to the message, such as, for example, a sender and/or receiver of the message, a time at which the message was sent and/or received, etc. The journaled message is stored in a database. In some examples, the journaled message is stored in its raw form. In other examples, the journaled message is stored in an encrypted form. In some examples, both the raw version and the encrypted version may be stored. In addition, a hash of the journaled message is stored on the blockchain. Storing the hash of the journaled message on the blockchain provides proof that the message has been stored accurately and has not been tampered with. This is because a third party, at a later date, can verify that the journaled message (which includes a copy of the message) hashes to the same hash that has been stored on the blockchain. This mechanism removes the need for trust in a third party.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of an example system for journaling messages,

FIG. 4 is a schematic block diagram of another example system for journaling messages,

FIG. 5 schematically illustrates an example hierarchical structure of encryption keys for journaled messages, and

FIG. 6 schematically illustrates an example hierarchical structure of encryption keys and payment keys for journaled messages.

### DETAILED DESCRIPTION OF EMBODIMENTS

### 1. Example System Overview

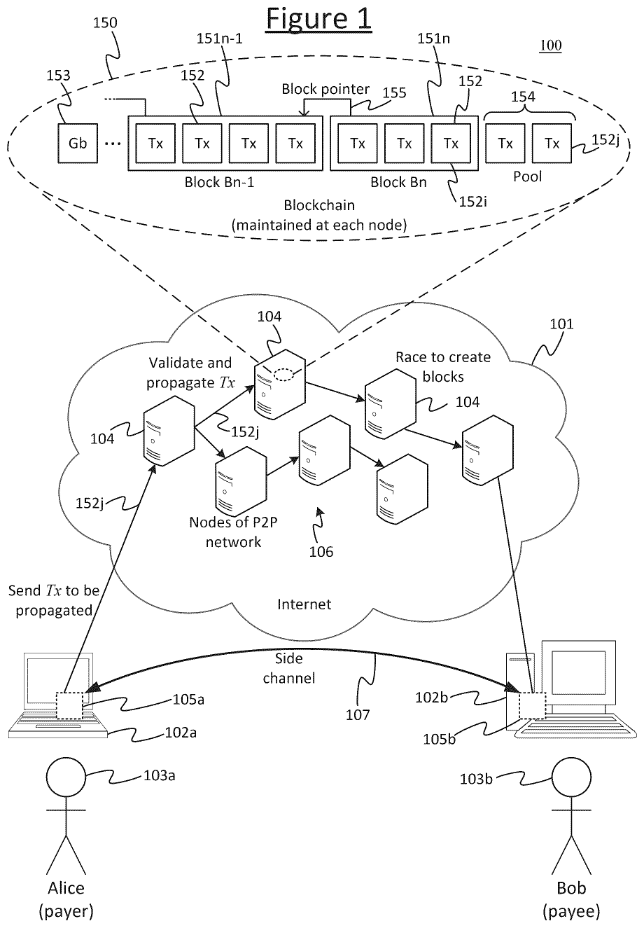

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

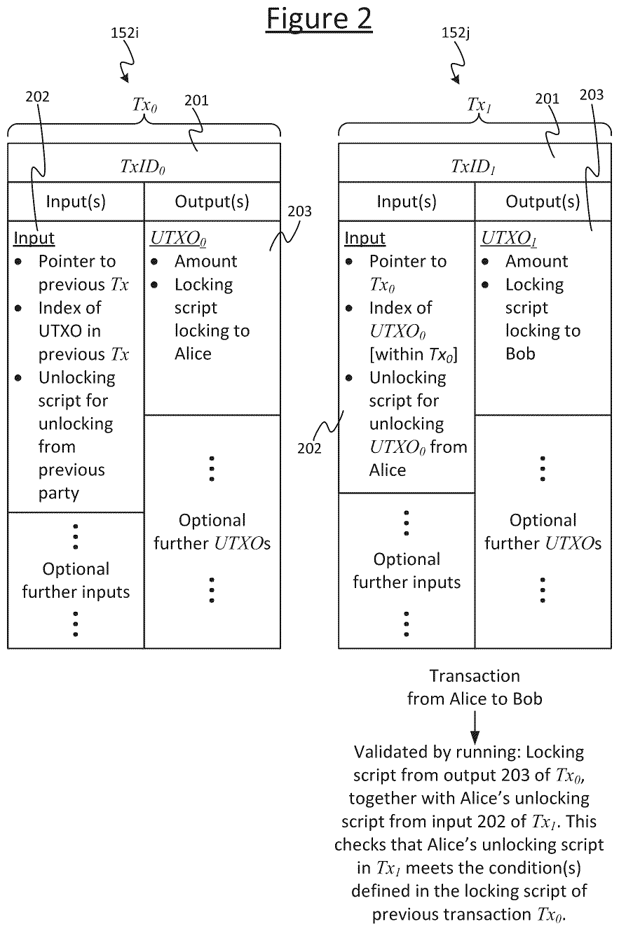

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>||[Checksig P_{A}]

where “||” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP _ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Message Journaling

Message Journaling typically refers to the process of creating a copy of incoming and/or outgoing messages while they are in transit. A journaled message contains a copy of the content of the actual message, any usually contains related metadata such as time, date, and the sender's/recipient's address involved in the communication.

Typical features of message journaling systems are:
Real-time: the messages are captured continuously, with the journaled message being created and sent to a storage system at the same time as the actual message is in transit.
Rule-based selective: a set of journal rules are set by the administers determining who to journal, what to journal and where to store journaled messages. The journaled messages are sent to a pre-determined mailbox.
Indexed: an identifier indicates that the email sending the journaled message to the pre-determined mailbox is part of the journaling protocol, rather than a normal email communication.
Searchable: the journaled messages can be searched by the index.

Journaling systems are typically based on the following principles:
Data Integrity: The data must be retained in its original state without being tampered with or deleted.
Data Security: The information retained is safeguarded against threats such as unauthorized human access, spyware and virus attacks.
Data Auditability: The information is auditable, easily accessible, and verifiable by authorized personnel.

Message Journaling systems that are currently commercially available offer cloud-based storage, and typically journal messages in real-time. Organisations are able to define the journal rules, rule scopes, journal recipient and journaling mailbox, to ensure they meet the requirements of regulation and compliance. A journaling report will be generated by the journal service and sent to the journaling mailbox automatically in real-time as messages are sent and received by users' mailboxes. The journal report is a specific message that saves the original journaled messages as an attachment. If the journaling mailbox is not available to receive the journal report, then an alternate journaling mailbox is used to receive the undelivered report. Typically, the alternate journaling mailbox is not provided by the main journaling system, but rather an on-premises or third-party archiving system.

Although existing journaling methods claim that they are immutable and can maintain the integrity of the journaled data, the claim could be challenged due to their off-chain nature. There is currently no way to verify whether a journaled message has been modified or deleted, and so users must trust the message journaling system.

### 5. Blockchain-Based Message Journaling

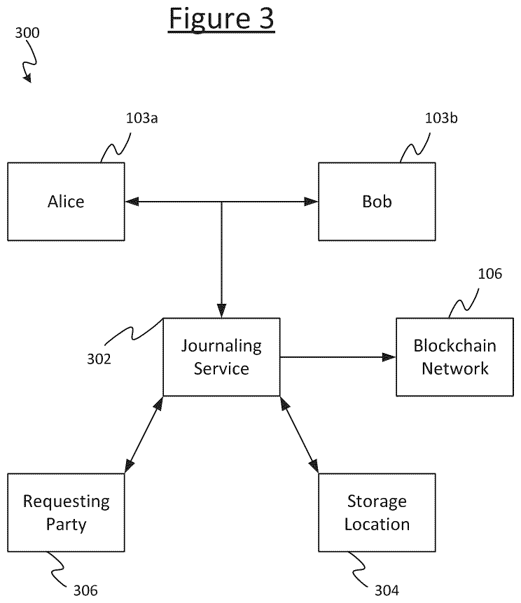

Embodiments of the present disclosure relate to a blockchain-based messaging journaling system and protocol. FIG. 3 illustrates an example system 300 for implementing such embodiments. The system 300 comprises a journaling service 302 and two or more parties. The journaling service 302 is connected to and configured to communicate with the blockchain network 106. The journaling service 302 comprises and operates computer equipment, the computer equipment comprising processing apparatus including one or more processors, e.g. one or more central processing units (CPUs), accelerator processors, application specific processors and/or field programmable gate arrays (FPGAs), and other equipment such as application specific integrated circuits (ASICs). The computer equipment of the journaling service 302 also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

In the example of FIG. 3, the parties are shown as users Alice 103a and Bob 103b. However in general the parties may take any form such as, for example, individual users, groups of users, companies, organisations, universities, government bodies, etc. Moreover, whilst the parties will be described in terms of Alice 103a and Bob 103b, the parties themselves (or rather their respective computer equipment) need not have any blockchain-related capabilities. On that note, it will be appreciated that any action described as being performed by Alice 103a or Bob 103b is in fact performed by their respective computer equipment.

The system 300 also comprises a storage location 304. The storage location 304 is shown separate from the journaling service 302 in FIG. 3, with the journaling service 302 being connected to the storage location 304 (e.g. via a wired or wireless connection). For example, the journaling service 302 may be connected to the storage location 304 via the Internet. In other examples, the journaling service comprises the storage location 304. The storage location 304 may be dedicated memory operated by the journaling service 302. In other examples, the storage location 304 may be cloud-based and be comprised by one or more servers. Note that the storage location 304 is not the blockchain 150.

The system 300 further comprises a requesting party 306. In general, the requesting party 306 may take any form (e.g. a user, organisation, company, etc.). In some examples, the requesting party 306 is an auditor. Whilst not shown in FIG. 3, the requesting party 306 may be connected and configured to communicate with the blockchain network 106.

The journaling service 302 is configured to journal messages sent to and/or from Alice 103 and/or Bob 103b. For simplicity, embodiments will primarily be described in terms of journaling message sent to or from Alice 103a. Herein, “a journaled message” is taken to mean data comprising at least a copy of a message. Therefore “journaling a message” is taken to mean saving a copy of a message, and optionally, metadata pertaining to the copied message.

The journaling service 302 first determines that a message that has been sent by, or received by, Alice 103a is to be journaled. In some examples, all messages that are sent by, or received by, Alice 103a are to be journaled. In other examples, only certain types of messages are to be journaled, e.g. messages sent to and/or from particular parties (e.g. all messages sent to and/or from Bob 103b), messages sent and/or received during a particular time window, containing particular content (e.g. key words), etc. The journaling service 302 may determine whether a message satisfies one or more conditions before journaling the message.

Having determined that a message (a “first message”) is to be journaled, the journaling service 302 generates a journaled message (a “first journaled message”). Here, “first” is used merely as a distinguishing label, and does not necessarily imply an order. That is, the first message need not necessarily be the first ever message to be journaled. The first journaled message comprises a copy of the first message. In some examples, the first journaled message consists of the first message. In other examples, the first journaled message comprises additional metadata. For instance, the first journaled message may comprise a sender of the first message (e.g. Alice 103a) and/or a recipient of the first message (e.g. Bob 103b). Other metadata, such as a timestamp, message type, priority, etc. may be included as part of the first journaled message.

The journaling service 302 stores the first journaled message at the storage location 304. As explained below, the first journaled message may be encrypted, with the encrypted version being stored either in addition to, or instead of the plaintext version of the first journaled message. Depending on the type of storage, storing the first journaled message may comprise the journaling service 302 storing the first journaled message in internal memory, or sending the first journaled message to remote storage, e.g. cloud storage.

In some examples, journaled messages are encrypted before being stored at the storage location 304. For example, the first journaled message may be encrypted before being stored. That is, the journaling service 302 may encrypt the first journaled message to generate a first encrypted journaled message, and store the first encrypted journaled message at the storage location 304 (instead of the plaintext first journaled message). Any suitable encryption scheme may be used, including symmetric and asymmetric encryption.

In addition, the journaling service 302 generates a hash (a “first hash”) of the first journaled message. The first hash is generated by hashing at least the first journaled message with a hash function, e.g. a cryptographic hash function such as a SHA-based hash function, e.g. SHA256. Other types of hash functions may be used. The journaling service 302 submits a transaction (a “first transaction”) to the blockchain network 106, wherein the first transaction includes the first hash. The first transaction may be signed by the journaling service 302.

The first transaction has a transaction identifier (a “first transaction identifier” or first TxID). The journaling service 302 may store the journaled message at the storage location 304 mapped to the first TxID. That is, a data-pair comprising the first journaled message and the first TxID may be stored at the storage location 304. The first journaled message and TxID may be stored in a database at the storage location. When the first transaction is accepted onto the blockchain, a block number of the block in which the first transaction is recorded may be obtained and mapped to the first transaction stored at the storage location 304. The first journaled message may be mapped to either the first TxID or both the first TxID and the block number.

In some examples, the first message may have a message index (a “first message index”). The first message index may be generated by the journaling service 302. In general, the journaling service 302 may journal multiple messages, and the message index indicates a position of a particular journaled message in an order of journaled messages. The journaling service 302 may store the first journaled message at the storage location mapped to the first message index, e.g. in addition to the first TxID and/or block number.

Note that the hashed journaled message (e.g. the first hash of the first journaled message) is a hash of the plaintext journaled message, and not of the encrypted journaled message.

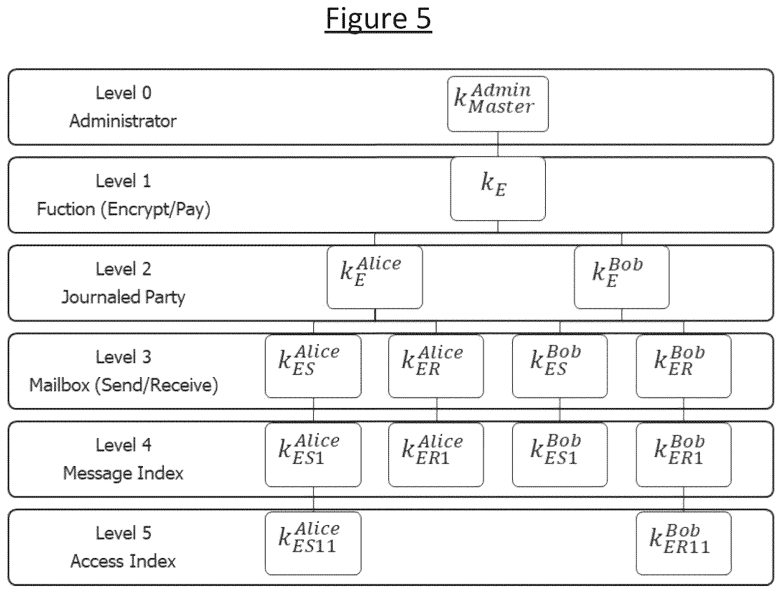

In some examples, the journaling service 302 may generate and maintain a hierarchical key structure (e.g. a hierarchical deterministic (HD) wallet of keys), where each key is linked to a master key. An example structure is shown in FIG. 5. The key structure may comprise a first branch of keys, where at least some keys in the first branch are to be used for encrypting journaled messages. Each key in the branch (the “encryption branch”) is linked to a master encryption key (e.g. key k_{E} in FIG. 5). Note that although termed the encryption branch, not all keys in that branch need be used for encrypting messages. For example, some keys may only be used to derive child keys within the key structure. The encryption branch comprises keys in several layers of the structure. Each key has a respective index. The encryption branch comprises a layer of message keys (or message index keys). The encryption branch may include other layers, such as a function layer, a party layer, and a mailbox layer. Each message key is associated with a respective journaled message. For example, message key k_{ES1} in FIG. 5 is associated with the first journaled message. The journaling service may use keys (“encryption keys”) derived from the message key associated with the first journaled message to encrypt the first journaled message. For example, encryption key k_{ES11} in FIG. 5 may be used to encrypt the first journaled message for the first time, and encryption key k_{ES12} in FIG. 5 may be used to encrypt the first journaled message for a second time (re-encryption is discussed below).

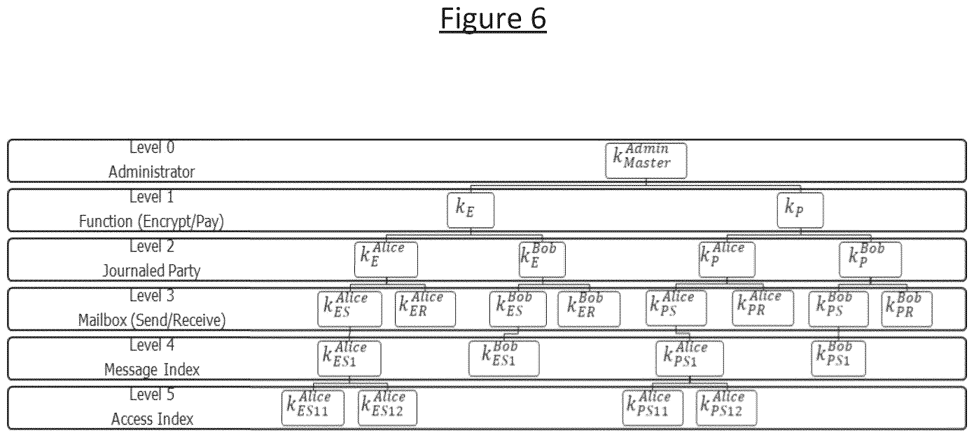

Returning now to the storing of the hashed journaled message on-chain. The first hash of the first journaled message may be stored in either a spendable or unspendable output of the first transaction. Regardless, the first transaction contains at least one spendable output (which may or may not contain the first hash). The spendable output is locked to a payment public key generated by the journaling service 302. In some examples, the hierarchical key structure may contain a second branch of keys (a “payment branch”). The public key used to lock the spendable output may occupy a position in the payment branch corresponding to the encryption key used to encrypt the first journaled message. An example of a key structure containing an encryption branch and a payment branch is shown in FIG. 6. Payment key k_{PS11} in FIG. 6 may be used to derive the payment public key to which the spendable output of the first transaction is locked. More details on the key structure are provided below in section 6.

As mentioned above, the journaling service 302 may journal many messages. The journaling service 302 uses a similar process described for each journaled message. That is, for each respective message to be journaled, the journaling service 302 generates a respective journaled message comprising a copy of the respective message, and stores the respective journaled message (or an encrypted version thereof) at the storage location 304. The journaling service 302 also generates a respective hash of the journaled message and stores the respective hash on the blockchain 150 in a respective transaction. When encrypting the respective messages, the journaling service 302 may use a respective encryption key from the same hierarchical key structure. Each encryption key is derived from a message key associated with the respective journaled message (i.e. the message key has an index corresponding to an index of the respective journaled message). For example, if message key k_{ES1} in FIG. 5 is associated with the first journaled message, then a second journaled message may be associated with message key k_{ES2}, a third journaled message may be associated with message key k_{ES3}, and so on. Similarly, the spendable output of each respective transaction may be locked to a respective payment key from the same hierarchical key structure. Each payment key is derived from a message key associated with the respective journaled message (i.e. the message key has an index corresponding to an index of the respective journaled message). For example, if message key k_{PS1} in FIG. 6 is associated with the first journaled message, then a second journaled message may be associated with message key k_{PS2}, a third journaled message may be associated with message key k_{ES3}, and so on.

Moving now to the process of a requesting party 306 verifying the integrity of a journaled message. The requesting party 306 may request access to a journaled message, e.g. the first journaled message. In response, the journaling service 302 retrieves the encrypted journaled message from the storage location 304, decrypts the encrypted journaled message and sends the decrypted journaled message (i.e. the first journaled message) to the requesting party 306. In examples where the journaled messages are not stored in encrypted form, the journaling service 302 retrieves the first journaled message from the storage location 304 and proves the first journaled message to the requesting party 306. The requesting party 306 may then verify that the first journaled message hashes to the same first hash that is stored in the first transaction on the blockchain 150. In some examples, the journaling service 302 provides the first TxID to the requesting party 306. The block number and/or message index mapped to the first journaled message may also be provided to the requesting party 306.

In some examples, once a journaled message has been accessed by (i.e. provided to) the requesting party 402, the journaling service 302 submits a transaction (a “second transaction”) to the blockchain network 106 which comprises a double-hash of at least the journaled message. If the journaled message is accessed again, a third transaction comprises a triple-hash of the journaled message may be sent to the blockchain network 106, and so on. The pre-image may contain other data such as, for example, a name of the requesting party 402, a timestamp at which the journaled message was accessed, etc. Each time a new transaction is generated to store a new hash value, (e.g. the double-hash of the journaled message), the TxID of the new transaction map be appended to the previous TxID mapped to the journaled message at the storage location 402. This creates a record of the chain, or history, of the transactions associated with a particular journaled message.

Note that in examples where the next transaction in the chain spends the spendable output from a previous transaction, the link between the transactions is apparent on-chain. In this case, the transaction chain history does not necessarily have to be explicitly recorded in the storage location 402.

In examples where there is no spending link between the first, second, etc. transactions (i.e. there is an independent transaction notarising each access), the transaction chain may be written to the storage location 402.

In examples where the journaled message is stored in encrypted form at the storage location 402 and requires decrypting in order for the journaled message to be accessed, the journaling service 302 may re-encrypt the journaled message with a new encrypted key each time the journaled message is accessed, and store the re-encrypted journaled message at the storage location 304. The encryption key used to encrypt the journaled message for the second time may be a second key derived from the same message key. For example, the encryption key k_{ES12} may be used to encrypt the first journaled message for the second time. If the first journaled message is accessed a third time, it may be re-encrypted with a third encryption key, e.g. k_{ES13}.

Similarly, each new transaction that is used to store an updated hash of the journaled message may have a spendable output locked to a new payment public key. The payment public key may be derived from a payment key in the payment branch of the key structure, where the position of the payment key corresponds to the position of the encryption key used to re-encrypt the first journaled message. For example, the second transaction that stores the double-hash of the first journaled message may have an output locked to payment key k_{PS12}.

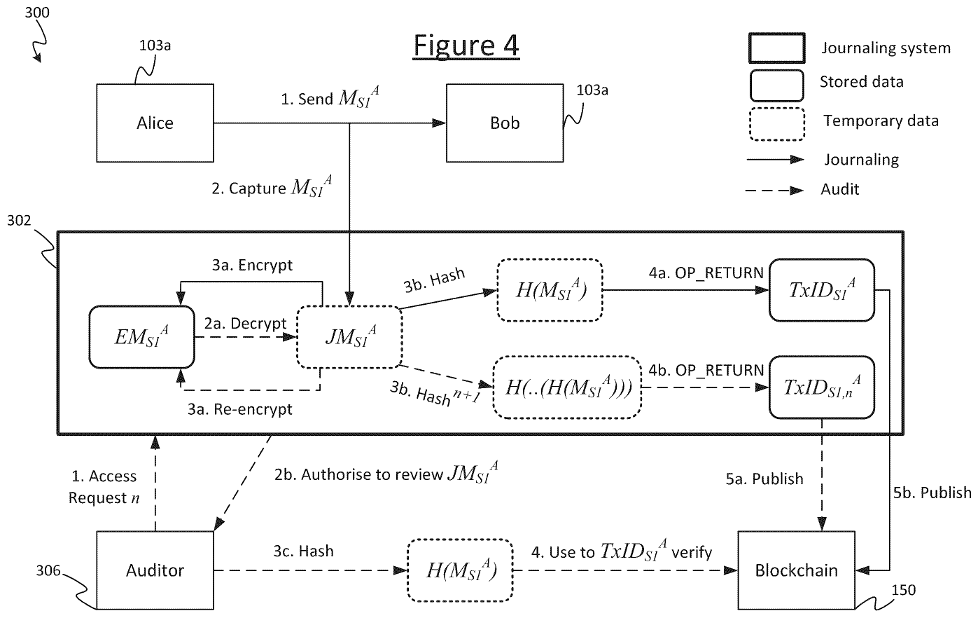

FIG. 4 illustrates a more detailed version of the message journaling system 300 described step 2, the journaling service 302 captures a copy of the message

$${M}_{S 1}^{A}$$

sent from Alice 103a to Bob 103b. In step 1, Alice 103a sends message

$${M}_{S 1}^{A}$$

to Bob 103b. In step 2, the journaling service 302 captures a copy of the message

$${M}_{S 1}^{A}$$

to generate a journaled message

$${JM}_{S 1}^{A} .$$

The journaling process will now be described. Reference is made to the solid arrowed-lines. In step 3a, the journaled message

$${JM}_{S 1}^{A}$$

is encrypted to generate an encrypted journaled message

$${EM}_{S 1}^{A} .$$

In step 3b, a hash of the journaled message

$$H ( {M}_{S 1}^{A} )$$

is generated and in steps 4 and 5 a transaction having transaction identifier TxID_{S1} is created and stored on the blockchain 150. The encrypted journaled message

$${EM}_{S 1}^{A}$$

is stored in a journaling database together with the transaction identifier TxID_{S1}^{A}.

The access process will now be described. Reference is made to the dashed arrowed-lines. In this example, the requesting party 306 is an auditor. In step 1, the auditor 306 sends an access request to the journaling service 302. In step 2a, the journaling service 302 decrypts the encrypted journaled message

$$E {M}_{S 1}^{A}$$

to obtain the journaled message

$${JM}_{S 1}^{A} ,$$

and in step 2b, the journaled message

$${JM}_{S 1}^{A}$$

is sent to the auditor 306. In step 3a, the journaled message

$${JM}_{S 1}^{A}$$

is re-encrypted. In step 3b, a double-hash of the journaled message

$$H ( H ( {M}_{S 1}^{A} ) )$$

is generated, and in steps 4b and 5b, a transaction having transaction identifier TxID_{S1}_{ₙ}^{A} is stored on the blockchain 150. Here, n refers to the nth time the journaled message is accessed. From the auditor's perspective, in step 3c, the auditor 306 hashes the journaled message

$${JM}_{S 1}^{A} ,$$

and in step 4b the auditor optains a transaction having transaction identifier TxID_{S1}^{A} and verifies that the hash contained in the transaction matches the hash of the journaled message. If the hashes match, the auditor 306 can be sure that the journaled message has not been tampered with or otherwise changed.

Note that the labelling/numbering of the steps in FIG. 4 is for illustrative purposes only. In some examples, some steps may occur in a different order. Similarly, some steps may occur in parallel.

### 6. Example Implementation

This section describes a specific implementation of the blockchain blockchain-based message journaling protocol described above, including the journaling process and an access chain protocol. The access chain allows for recording the order and timestamp of each access on the blockchain. This protocol achieves at least two goals:
Maintain the integrity of the journaled messages.
Manage the access control to the journaled messages

### 6.1 Definition and Features

A journaled message may be defined as, for example, a copy of an original message including the message itself, the sender's name and address, the recipient's name and address, and the corresponding timestamps. Additional metadata may also be included in the journaled message e.g. based on organisational preferences. Once an original message matches the journaled rules, the message text and associated metadata will be captured automatically when it is in transit and sent to a journaling destination.

A journaling destination may be a mailbox or other storage server. In this example journaling protocol, the journaling destination is an on-premises storage server managed by the organization's administrator. The journaled messages are encrypted and saved on this on-premises server This allows organizations to flexibly select the encryption scheme to meet the organization requirements, and further to manage the access control that requires a decryption key. However, note that this local server can optionally be real-time mirrored on, periodically backed up to, or even replaced by cloud servers. Although cloud services typically encrypt stored data (and automatically decrypt it at the point of user access), this is independent from the encryption implemented by the journaling system, and there are no compatibility restraints related to different encryption formats.

The journaling protocol journals messages in real-time, i.e., the journal message is created at the point a message is sent or received by the user's mailbox. At the same time, the hash of the journal message (including original message text and metadata) is published onto the blockchain. This provides a time-stamped, immutable record of the journaled message, which can be used at any time to verify the integrity of the on-server copy.

The parties involved in the message journaling protocol are message senders, message recipients, administrators and auditors. Among them, the senders and recipients of journaled messages are referred to as journaled parties.

Some features of this example message journaling protocol are:
Encrypted—all the journaled messages are encrypted, and the encrypted copies can only be accessed by the administrators and/or auditors. Journaled parties are not able to access them.
Verifiable—the integrity of journaled messages can be verified against an immutable, timestamped hash of the message that is stored on the blockchain. This maintains data privacy while allowing proof of integrity.
Searchable—the journaled message is searchable by the transaction ID.
Accountable—journaled parties know they are being journaled, and can use their original messages to verify the hash value of their journaled message that is published on the blockchain.

### 6.2 Encryption

The encryption is implemented by the administrator, and there is no interaction between journaled parties and the administrator during the encryption. Therefore symmetric encryption scheme is sufficient to encrypt the journaled messages.

The encryption keys for different journaled parties are managed through a hierarchical structure (see FIG. 5 as an example). The hierarchical structure allows the administrator to track and manage all encryption keys. Suppose

$${k}_{Master}^{Ad min}$$

Is the administrator's master secret key (Level 0 in FIG. 5). According to BIP 43 and 44, a secret key k_{E} (Level 1) is derived from

$${k}_{Master}^{Ad min}$$

for encryption purposes. For simplicity, it is assumed that there are two journaled parties Alice and Bob in the journaling protocol. Level 2 has child secret keys

$${k}_{E}^{A l i c e} and {k}_{E}^{B o b}$$

for the journaled messages of Alice and Bob, respectively. Level 3 creates

$${k}_{E S}^{A l i c e} and {k}_{E R}^{A l i c e} ,$$

derived from

$${k}_{E}^{A l i c e}$$

that correspond to Alice's sent vs. received mailboxes. From each key at that level, one derive a series of child keys (Level 4) to represent each message in the mailbox: for instance, from

$${k}_{E S}^{A l i c e}$$

we will derive

$${k}_{E S 1}^{A l i c e}$$

for Alice's first sent message,

$${k}_{E S 2}^{A l i c e}$$

for her second sent message, and so on. Note that keys in levels 0-4 are only used to create the tree structure. Level 5 contains the keys used for encryption. As the lowest level of the key hierarchy these keys cannot be used to derive the value of other keys in the structure, so even in the case where a single key is compromised, the attack will be limited to a single record. Each time a message is accessed, it is re-encrypted—this allows strict access control and monitoring of each access. When a message is first journaled, it is encrypted using the first child key, e.g. Alice's first sent message will initially be encrypted using key

$${k}_{E S 11}^{A l i c e} .$$

If it is accessed, the message will be re-encrypted using key

$${k}_{ES 12}^{Alice} .$$

Note that, in some examples, all the secret keys are managed by the administrator, but these keys can be generated and derived by the software. This allows processes like key generation and management, encryption, decryption, and signature and transaction generation to be automated and performed behind the scenes.

### 6.3 Processes

For brevity, it is assumed:
JM is the journaled message, i.e. a copy of the original message and its metadata.
H is the hash of JM and will be published on the blockchain via a blockchain transaction.
EM is the encrypted JM and saved on the journaling destination. This location may be an on-premises server that the administrator sets up.

Once a message satisfies the journal rules, it will be journaled, encrypted, and stored in the journaling destination in a data structure, which we refer to as the journaling database. The hash of the journaled message will be published onto the blockchain, e.g. using an OP_RETURN in the output of a transaction. Note that the journal rules should be known by journaled parties, including what information will be captured in the journaling process.

### 6.4 Journaling Protocol

Suppose Alice 103a is an internal user, and all her sending messages are required to be journaled. She sends a message to Bob 103b who could be internal or external. If Bob is an internal user and is targeted as a journaled party, then the journaling process is applied to the messages that Bob receives, as described in the section below. If Bob is an external user, then the journaling process is only applied to Alice's sending messages.

First will be described the process of message journaling from a sender (Alice) point of view.
1. Alice's message is copied as it is sent, creating

$${JM}_{S 1}^{Alice}$$

in journaling system.
2.

$${JM}_{S 1}^{Alice}$$

is encrypted with a secret key

$${k}_{ES 11}^{Alice} ,$$

which is shown in FIG. 5.
3. The encrypted

$${JM}_{S 1}^{Alice}$$

is denoted a

$${EM}_{S 1}^{Alice}$$

and saved in the journaling database.
4. The hash value

$${H}_{S 1}^{Alice}$$

of

$${JM}_{S 1}^{Alice}$$

is calculated and stored using the script OP_RETURN in the output of a transaction

$${TxID}_{S 11}^{Alice}$$

published onto the blockchain. The transaction ID

$${TxID}_{S 11}^{Alice}$$

is saved in the journaling database and is used as the link to

$${JM}_{S 1}^{Alice} ,$$

shown in Table 1 below.

The hash value stored on chain is the hash of the (raw) journaled message, not of the encrypted message. This allows the journaled party to verify the integrity of the on-chain hash using their original message, without access to encryption keys, and maintains user privacy as the raw message data is not stored on-chain.

Now, suppose Bob is an internal user and the message he receives from Alice above is journaled. The journaling process is similar to the above, as shown below:
1. Bob's message from Alice is copied as it is received by his mailbox server, creating

$${JM}_{R 1}^{Bob}$$

in the journaling system.
2.

$${JM}_{R 1}^{Bob}$$

is encrypted with a secret key

$${k}_{ER 11}^{Bob} .$$

3. The encrypted

$${JM}_{R 1}^{Bob}$$

is denoted a

$${EM}_{R 1}^{Bob}$$

and saved in the journaling database.

4. The hash value

$${H}_{R 1}^{Bob}$$

of

$${JM}_{R 1}^{Bob}$$

is calculated and stored into an OP_RETURN output of a Bitcoin transaction

$${TxID}_{R 11}^{Bob}$$

published onto the blockchain. The transaction ID TxID_{R11}^{Bob} is saved on the journaling database and linked to

$${JM}_{R 1}^{Bob} ,$$

as shown in Table 1.

It is worth noting that the sent message from Alice to Bob is denoted as

$${JM}_{S 1}^{Alice}$$

on Alice's side and

$${JM}_{R 1}^{Bob}$$

on Bob's side. Although the original messages have the same content, the journaled version will have different timestamps and potentially different journaling metadata (e.g. Alice and Bob are internal users of different companies which have different journal rules), and consequently their hashes

$${H}_{S 1}^{Alice} and {H}_{R 1}^{Bob}$$

will have different values. Note that the two versions of the journaled message are notarised in separate transactions on the blockchain.

### 6.5 Journaling Database

Journaled messages are stored on the server in a data structure, which is referred to as the journaling database. The format of the structure is not formally defined herein, but may store the encrypted message data and link each encrypted message to its message index and the transaction ID and block number of the on-chain hash commitment. Other optional fields such as journaled party, mailbox and timestamp can be included to aid search functionality, and details of access request history (access index, requesting party, time, date, etc.) can also be recorded if required.

The journaling database is accessible directly by administrators, but not by journaled parties or auditors. The administrator can set up a look up table for each journaled party that allows them to view only the records in the journaling database that correspond to their messages.

Similarly, auditors can view the subset of records that meet their audit criteria. Note that the content of the messages is always encrypted in the database and decryption key access is controlled by the administrators and implemented by the journaling system.

TABLE 1
Example of the journaling database linking journaled message
indices, encrypted message cyphertext, and corresponding
TxIDs. Sample entries are given for illustration.

| Journaled | | Message | Encrypted message | |
|---|---|---|---|---|
| party | Mailbox | Index | cyphertext | TxID |
| Alice | Sent | 1 | EM_{S1}^{Alice} | TxID_{S11}^{Alice} |
| Alice | Sent | 2 | EM_{S2}^{Alice} | TxID_{S21}^{Alice} |
| Alice | Received | 1 | EM_{R1}^{Alice} | TxID_{R11}^{Alice} |
| Bob | Sent | 1 | EM_{S1}^{Bob} | TxID_{S11}^{Bob} |
| Bob | Received | 1 | EM_{R1}^{Bob} | TxID_{R11}^{Bob} |

### 6.6 Blockchain Transaction Format and Payment Keys

When transactions are created on the blockchain, the output (in which the journaled message hash may be stored) is locked to a public key. A new public/private keypair is generated each time a journaled message hash is stored on-chain. This may be implemented automatically by the journaling system. A payment key derivation system based on a secret key derived from the master secret key

$${k}_{Master}^{Admin} ,$$

in a branch that runs parallel to the encryption keys, is used. This allows the key index within the payment branch to match the index in the encryption branch.

First, one derives a secret key kₚ used for payments from the master secret

$${k}_{Master}^{Admin} ,$$

as shown in FIG. 6. Each time an encryption secret key for Alice's journaled message is generated, a parallel payment private key is also created. For example,

$${k}_{E S 11}^{Alice}$$

is generated for encrypting

$${JM}_{S 1}^{Alice} ,$$

and the payment private key

$${k}_{PS 11}^{Ali ce}$$

is also generated for use in

$${TxID}_{S 11}^{Alice} ,$$

as shown in FIG. 6.

Table 2 shows an example blockchain transaction that is created when a message is first journaled. For simplicity, inputs and outputs that may be necessary to cover transaction fees and change are omitted. The hash value

$$( {H}_{S 1}^{Alice} ) ,$$

is stored in the output of the transaction via an OP_RETURN code. The remaining locking script is a standard P2PKH script based on the public key associated with the newly generated payment key, i.e.

$${PK}_{PS 11}^{Alice} = {k}_{PS 11}^{Alice} * G ,$$

where ‘*’ denotes elliptic curve scalar multiplication and G is the elliptic curve generator point.

TABLE 2
Example blockchain transaction for the initial journaling of a message. The input
UTXO is any UTXO controlled by the admin or journaling system. The output is locked to the
$public key hash of the payment key {k}_{PS 11}^{Alice} . The jornaled message hash is embedded in the$
output via an OP_RETURN code.
${TxID}_{S 11}^{Alice}$

| | Inputs | | | | |
|---|---|---|---|---|---|
| | | Unlock | | Outputs | |
| Index | Outpoint | script | nSeq | Value | Lock script |
| 0 | Admin UTXO | <sig> | n | x | OP_DUP OP_HASH160 |
| | | <PK_{A}> | | | $< H ( {PK}_{PS 11}^{Alice} ) > OP\_EQUALVERIFY$ |
| | | | | | $OP\_CHECKSIG OP\_RETURN < {H}_{S 1}^{Alice} >$ |

| | |
|---|---|
| Version | Locktime |

### 6.7 Verification

The message journaling system provides for the integrity of the journaled message to be verifiable. This is achieved by comparing the journaled or original message to the timestamped, immutable hash published on the blockchain.

Auditors request access to a journaled message from the administrators and receive access to the decrypted journaled message. This process is described below. The respective transaction ID of one or more blockchain transactions that contain a respective hash of the journaled message may be linked to each journaled message in the journaling database, allowing auditors to locate the respective hash of the journaled message on the blockchain. They can then hash the decrypted journaled message and compare the two hash values to determine whether the journaled message integrity is intact.

An auditor might want to prove that when the message was first journaled (and timestamped on chain) it was the same as the version they now have access to. In this case, the auditor requires the TXID of the first transaction in the access chain. As another example, the auditor may wish to audit the access chain (e.g. check that only authorised persons accessed the data), in which case they would need to view the access chain records and all the corresponding transactions.

Journal parties may also want to check that the journaled message copy is identical to their original message. They can use their lookup table to find the associated transaction ID and locate the hash on-chain. Since they have access to the original message, they do not need to decrypt the journaled copy. Instead, the journaled message can be reconstructed based on the journaling format rules and hashed. If the hash values match, the user knows their message has been accurately journaled.

### 6.8 Access Chain

The hash value of the journaled message is recorded on the blockchain to maintain the integrity of the journaled message. Each time a party (such as an auditor) requests a decryption key for a journaled message, the access request can be recorded on the blockchain by creating a new transaction that spends the UTXO from the current transaction associated with that journaled message. Thus, all the transactions corresponding to access of a single journaled message will be linked on the blockchain via the spend of UTXOs—this is referred to as an access chain. Access requests are also reflected in the journaling database by updating the access chain of transactions and re-encrypting the journaled message. This allows administrators and journaled parties to track and verify the access history of journaled messages by the corresponding transactions.

### 6.9 Key Management

When a new decryption request is initiated (by an auditor or an administrator), two new keys are generated within the key structure: one in the encryption branch (e.g.,

$${k}_{ES 12}^{Alice} ) ,$$

and one in the payment branch (e.g.,

$${k}_{PS 12}^{Alice} ) .$$

Key generation follows the structure described above. Note that the second numerical index used throughout this white paper (i.e., index j for

$${k}_{ES ij}^{Alice} )$$

is incremented with each access. This is illustrated in Level 5 in FIG. 5 and FIG. 6. The access index (FIG. 5) can be derived from the number of TxIDs listed for each journaled message, or included explicitly in the journaling database.

The payment key is used as the private key to generate the public key

$${PK}_{PS 12}^{Alice} = {k}_{PS 12}^{Alice} * G ,$$

that is used for the new transaction. The encryption key

$${k}_{ES 12}^{Alice}$$

is used to re-encrypt

$${JM}_{S 1}^{Alice} .$$

This ensures that each time a journaled message is decrypted, a new decryption key request must be made, providing a comprehensive access history that is reflected on the blockchain and in the journaling database. It also supports security against encryption key theft or leakage.

As noted in the section on initial encryption, during the access process, key generation and derivation may be implemented by software within the journaling system. Similarly, the software may use the keys to decrypt and re-encrypt data and automatically execute steps in the protocol described below to run an access log.

### 6.10 Blockchain Transaction Format

When a decryption request occurs for a journaled message, say EM_{S1}^{Alice} the UTXO in the associated transaction

$${TxID}_{S 11}^{Alice}$$

is spent. The new transaction

$${TxID}_{S 12}^{Alice}$$

(Table 3) references

$${TxID}_{S 11}^{Alice}$$

as an input and requires a signature generated using the private key

$${k}_{PS 11}^{Alice} .$$

The output is a UIXO locked to the new public key

$${PK}_{PS 12}^{Alice} ,$$

and also includes the double hash of the journaled message in the OP_RETURN locking script.

TABLE 3
Example blockchain transaction to log the first access of a journaled message. The
input references the most initial transaction associated with the JM, and the output is locked
to the public key hash of the new payment key generated upon access. The double hash of
the journaled message is embedded in the output via an OP_RETURN code.
${TxID}_{S 12}^{Alice}$

| | Inputs | | | | |
|---|---|---|---|---|---|
| | | Unlock | | Outputs | |
| Index | Outpoint | script | nSeq | Value | Lock script |
| 0 | $[ {TxID}_{S 11}^{Alice} , 0 ]$ | <sig> | n | x | $OP\_DUP OP\_HASH160 < H ( {PK}_{PS 12}^{Alice} ) >$ |
| | | $< {PK}_{PS 11}^{Alice} >$ | | | OP_EQUALVERIFY_CHECKSIG |
| | | | | | $OP\_RETURN < H ( {H}_{S 1}^{Alice} ) >$ |

| | |
|---|---|
| Version | Locktime |

Note that this transaction includes the double hash value of the journaled message instead of the single hash that was used in the previous transaction. This helps protect the privacy of journaled parties as it makes it harder to identify the link between the data payload of the transactions. In this case, each access to the same journaled message will update the hash value on the blockchain via hashing the previous hash value.

The access chain formed by the access transactions provides an immutable record of how many times a record has been accessed, and when this access occurred. Additional metadata such as who viewed the record may be recorded in the journaling database and notarised on-chain. For example, an auditor may be required to provide a digital signature signing each request to review a record. This, along with a certificate that links their public key to their identity, current affiliation, and professional credentials, could be included in the access transaction on chain. This could be implemented in a number of ways. For example, the hash of the access metadata could be concatenated with the previous hash of the JM before the second hash is applied (e.g.

$$H ( [ H ( data ) , {H}_{S 1}^{Alice} ] ) ,$$

where data is the metadata relating to the access. In this case, for journaled parties to verify the access chain, would require that they have access to the raw metadata relating to each access. An alternative is that the metadata relating to the access chain is represented in a separate hash, either after the JM hash in the OP_RETURN, or in a separate output.

### 6.11 Access Protocol

Each time an auditor requires access to a record they must submit an access request. Access requests can be handled manually by administrators or automatically by the software after requiring the auditor to provide credentials.

Now is described the full protocol that occurs when an access request is granted, using the example of access to a single journaled message, though, in practice, many requests may occur simultaneously during an audit. If the auditor accesses Alice's journaled message such as

$${JM}_{S 1}^{Alice}$$

the journaling system will execute the following steps:
1. Decrypt

$${EM}_{S 1}^{Alice}$$

using the

$${k}_{ES 11}^{Alice}$$

and allow the auditor to view the decrypted

$${JM}_{S 1}^{Alice}$$

and the corresponding records such as journaled party ‘Alice’ and Mailbox ‘Sent’ in the journaling database. Note that the auditor uses the corresponding records to identify

$${TxID}_{S 11}^{Alice} .$$

They hash

$${JM}_{S 1}^{Alice}$$

and compare it to the hash value on chain to verify its integrity.
2. Derive a new encryption secret

$${k}_{ES 12}^{Alice}$$

from

$${k}_{ES 1}^{Alice} ,$$

and derive a parallel payment private key

$${k}_{PS 12}^{Alice}$$

from

$${k}_{PS 1}^{Alice} .$$

3. Calculate the associated payment public key

$$P {K}_{PS 12}^{Alice} .$$

4. Create a new transaction

$${TxID}_{S 12}^{Alice}$$

that spends the UTXO of

$${TxID}_{S 11}^{Alice}$$

and pays to

$${PK}_{PS 12}^{Alice} .$$

(Optional) Add metadata about the access request to the transaction.
5. Add the new

$${TxID}_{S 12}^{Alice}$$

to the journaled message's entry in the journaling database, as shown in Table 4.
6. Re-encrypt

$${JM}_{S 1}^{Alice}$$

using

$${k}_{ES 12}^{Alice}$$

and store in the journaling database(note, this should overwrite the previous encrypted message cyphertext, to ensure that old decryption keys cannot be reused).
7. (Optional) Update the journaling database with additional information about the access request, such as access index, requesting party, date and time of access etc.

TABLE 4
Updates to the journaling database indicate instances where journaled
messages were accessed.

| | | | Encrypted | |
|---|---|---|---|---|
| Journaled | | Message | message | |
| party | Mailbox | Index | (cyphertext) | TxID |
| Alice | Sent | 1 | ${EM}_{S 1}^{Alice}$ | ${TxID}_{S 11}^{Alice} \to {TxID}_{S 12}^{Alice} \to ⋯$ |
| Alice | Sent | 2 | ${EM}_{S 2}^{Alice}$ | ${TxID}_{S 21}^{Alice}$ |
| Alice | Received | 1 | ${EM}_{R 1}^{Alice}$ | ${TxID}_{R 11}^{Alice}$ |
| Bob | Sent | 1 | ${EM}_{S 1}^{Bob}$ | ${TxID}_{S 11}^{Bob}$ |
| Bob | Received | 1 | ${EM}_{R 1}^{Bob}$ | ${TxID}_{R 11}^{Bob}$ |

### 6.12 Overview and Features

FIG. 4 shows an overview of the processes that occur during initial message journaling and access for an example message M_{S1}^{Alice}.

The features of the access chain are summarised:
High level of user data privacy—personal data is not stored directly on-chain, but is notarised via a hash commitment that can be used to verify the integrity of the data stored in the journaling database. Further, while there is a chain of transactions indicating access history of each journaled message, the hash values stored in each subsequent transaction will differ. This is because after each access, one extra round of the hash function is applied to the data in the OP_RETURN (e.g. double hash→triple hash). This helps to obfuscate any links between the transactions and provides some privacy for the access history, which could otherwise be surmised by searching for transactions that contain a particular hash value.
One-time access—a encryption secret key can only be used to access encrypted journaled message from the journaling database once. The encryption of journaled messages will be updated with a new encryption secret once decrypted. If auditors want to access the journaled message again, they need to obtain a new decryption key from the administrator. This is helpful for the administrator to manage the access once handing over the decryption key to auditors.
On-chain access record—each access from the journaling database will be recorded on the blockchain via transactions. In this case, the timestamping and ordering of each access cannot be tampered with.
Trackable access—the new transaction ID will be updated in the journaling database. This makes it easy to search and track each access through these transaction IDs.

### 7. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method of journaling messages sent to and/or from a first party, wherein the method comprises:
determining a first message to be journaled, wherein the first message is sent to or from the first party;
generating a first journaled message, wherein the first journaled message comprises a copy of the first message;
storing the first journaled message and/or an encrypted version of the first journaled message at a storage location;
causing a first blockchain transaction to be sent to a blockchain network to be recorded on a blockchain, wherein the first blockchain transaction comprises a first hash generated by hashing at least the first journaled message.

Statement 2. The method of statement 1, wherein the first blockchain transaction has a first transaction identifier, and wherein the first journaled message and/or the encrypted version thereof is mapped to the first transaction identifier at the storage location.

Statement 3. The method of statement 2, wherein the first blockchain transaction is recorded in a first block of the blockchain, wherein the first block has a first block number, and wherein the first journaled message and/or the encrypted version thereof is mapped to the first block number at the storage location.

Statement 4. The method of any preceding statement, wherein the first message has a first message index, and wherein the first journaled message and/or the encrypted version thereof is mapped to the first message index at the storage location.

Statement 5. The method of any preceding statement, wherein the first journaled message comprises first metadata associated with the first message.

Statement 6. The method of statement 5, wherein the first metadata comprises one or more of: a sender of the first message, a recipient of the first message, a timestamp, a message type.

Statement 7. The method of any preceding statement, comprising:
encrypting the first journaled message to generate the encrypted version of the first journaled message; and
storing the encrypted version of the first journaled message at the storage location.

Statement 8. The method of any preceding statement, wherein the encrypted version of the first journaled message is generated using a symmetric encryption scheme.

Statement 9. The method of statement 7 or statement 8, wherein the first journaled message has a first journaled message index, and wherein the method comprises:
generating a hierarchal key structure comprising one or more layers of keys, each layer comprises one or more respective keys having respective key indexes, wherein the hierarchical key structure comprises a first branch of keys, and wherein encrypting the first journaled message comprises using a first encryption key derived from a first message key in the first branch of keys and having a first key index corresponding to the first journaled message index.

Statement 10. The method of statement 9, wherein the first blockchain transaction comprises a first spendable output locked to a first payment public key, wherein the hierarchical key structure comprises a second branch of keys, wherein the first payment public key is derived from a first payment key, and wherein the first payment key is derived from a first message key in the second branch of keys and having a first key index corresponding to the first journaled message index.

Statement 11. The method of statement 10, wherein the first hash value is stored in the first spendable output.

Statement 12. The method of statement 10, wherein the first hash value is stored in an output other than the first spendable output.

Statement 13. The method of any preceding statement, wherein said determining comprises determining whether the first message satisfies one or more conditions for journaling messages.

Statement 14. The method of any preceding statement, comprising:
determining a plurality of respective messages to be journaled;
generating a plurality of respective journaled messages, wherein each respective journaled message comprises a copy of the respective message;
storing the plurality of respective journaled messages and/or respective encrypted versions of the respective journaled messages at the storage location;
for each of the plurality of respective journaled messages, causing a respective blockchain transaction to be sent to the blockchain network to be recorded on the blockchain, wherein the respective blockchain transaction comprises a respective hash generated by hashing at least the respective journaled message.

Statement 15. The method of statement 14, comprising:
encrypting each respective journaled message to generate the respective encrypted version of the respective journaled message; and
storing each respective encrypted version of the respective journaled message at the storage location.

Statement 16. The method of statement 9 and statement 15, wherein encrypting each respective journaled message comprises using a respective encryption key derived from a respective message key in the first branch of keys and having a respective key index corresponding to the respective journaled message index.

Statement 17. The method of statement 10 and statement 16, wherein the respective blockchain transaction comprises a respective spendable output locked to a respective payment public key, wherein the respective payment public key is derived from a respective payment key, and wherein the respective payment key is derived from a respective message key in the second branch of keys and having a respective key index corresponding to the respective journaled message index.

Statement 18. The method of any preceding statement, comprising:
receiving, from a requestor, a request to access the first journaled message;
sending the first journaled message to the requestor.

Statement 19. The method of statement 7 and statement 18, comprising:
in response to receiving the request, decrypting the encrypted version of the first journaled message.

Statement 20. The method of statement 18 or statement 19, comprising:
providing the first transaction identifier to the requestor.

Statement 21. The method of any of statements 18 to 20, comprising:
causing a second blockchain transaction to be sent to the blockchain network to be recorded on the blockchain, wherein the second blockchain transaction comprises a second hash generated by double-hashing at least the first journaled message.

Statement 22. The method of any of statements 18 to 21, when dependent on statement 9, comprising:
re-encrypting the first journaled message to generate a re-encrypted version of the first journaled message; and
storing the re-encrypted version of the first journaled at the storage location, wherein re-encrypting the first journaled message comprises using a second encryption key derived from the first message key in the first branch of keys having the first key index corresponding to the first journaled message index.

Statement 23. The method of statement 21 or 22, when dependent on statement 10, wherein the second blockchain transaction comprises an input that references the first spendable output of the first blockchain transaction, and wherein the second blockchain transaction comprises a second spendable output locked to a second payment public key, wherein the second payment public key is derived from a second payment key, and wherein the second payment key is derived from the first message key in the second branch of keys having the first key index corresponding to the first journaled message index.

Statement 24. The method of any of statements 21 to 23, when dependent on statement 2, wherein the second blockchain transaction has a second transaction identifier, and wherein the method comprises:
appending the first transaction identifier mapped to the first journaled message and/or the encrypted version thereof with the second transaction identifier.

Statement 25. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 24.

Statement 26. A computer program embodied on computer-readable storage and configured so as, when run on one or more processors, to perform the method of any of statements 1 to 24.

1. A computer-implemented method of journaling messages sent to and/or from a first party, wherein the method comprises:
determining a first message to be journaled, wherein the first message is sent to or from the first party;
generating a first journaled message, wherein the first journaled message comprises a copy of the first message;
storing the first journaled message and/or an encrypted version of the first journaled message at a storage location;
causing a first blockchain transaction to be sent to a blockchain network to be recorded on a blockchain, wherein the first blockchain transaction comprises a first hash generated by hashing at least the first journaled message.

2. The method of claim 1, wherein the first blockchain transaction has a first transaction identifier, and wherein the first journaled message and/or the encrypted version thereof is mapped to the first transaction identifier at the storage location.

3. The method of claim 2, wherein the first blockchain transaction is recorded in a first block of the blockchain, wherein the first block has a first block number, and wherein the first journaled message and/or the encrypted version thereof is mapped to the first block number at the storage location.

4. The method of claim 1, wherein the first message has a first message index, and wherein the first journaled message and/or the encrypted version thereof is mapped to the first message index at the storage location.

5. The method of claim 1, wherein the first journaled message comprises first metadata associated with the first message.

6. The method of claim 5, wherein the first metadata comprises one or more of: a sender of the first message, a recipient of the first message, a timestamp, a message type.

7. The method of claim 1, comprising:
encrypting the first journaled message to generate the encrypted version of the first journaled message; and
storing the encrypted version of the first journaled message at the storage location.

8. The method of claim 1, wherein the encrypted version of the first journaled message is generated using a symmetric encryption scheme.

9. The method of claim 7-or claim 8, wherein the first journaled message has a first journaled message index, and wherein the method comprises:
generating a hierarchal key structure comprising one or more layers of keys, each layer comprises one or more respective keys having respective key indexes, wherein the hierarchical key structure comprises a first branch of keys, and wherein encrypting the first journaled message comprises using a first encryption key derived from a first message key in the first branch of keys and having a first key index corresponding to the first journaled message index.

10. The method of claim 9, wherein the first blockchain transaction comprises a first spendable output locked to a first payment public key, wherein the hierarchical key structure comprises a second branch of keys, wherein the first payment public key is derived from a first payment key, and wherein the first payment key is derived from a first message key in the second branch of keys and having a first key index corresponding to the first journaled message index.

11. The method of claim 10, wherein the first hash is stored in the first spendable output.

12. The method of claim 10, wherein the first hash is stored in an output other than the first spendable output.

13. The method of claim 1, wherein said determining comprises determining whether the first message satisfies one or more conditions for journaling messages.

14. The method of claim 1, comprising:
determining a plurality of respective messages to be journaled;
generating a plurality of respective journaled messages, wherein each respective journaled message comprises a copy of the respective message;
storing the plurality of respective journaled messages and/or respective encrypted versions of the respective journaled messages at the storage location;
for each of the plurality of respective journaled messages, causing a respective blockchain transaction to be sent to the blockchain network to be recorded on the blockchain, wherein the respective blockchain transaction comprises a respective hash generated by hashing at least the respective journaled message.

15. The method of claim 14, comprising:
encrypting each respective journaled message to generate the respective encrypted version of the respective journaled message; and
storing each respective encrypted version of the respective journaled message at the storage location.

16-17. (canceled)

18. The method of claim 1, comprising:
receiving, from a requestor, a request to access the first journaled message;
sending the first journaled message to the requestor.

19. (canceled)

20. The method of claim 18, comprising:
providing a first transaction identifier to the requestor, wherein the first transaction identifier is associated with the first blockchain transaction.

21. The method of claim 18, comprising:
causing a second blockchain transaction to be sent to the blockchain network to be recorded on the blockchain, wherein the second blockchain transaction comprises a second hash generated by double-hashing at least the first journaled message.

22-24. (canceled)

25. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of journaling messages sent to and/or from a first party, wherein the method comprises:
determining a first message to be journaled, wherein the first message is sent to or from the first party;
generating a first journaled message, wherein the first journaled message comprises a copy of the first message;
storing the first journaled message and/or an encrypted version of the first journaled message at a storage location;
causing a first blockchain transaction to be sent to a blockchain network to be recorded on a blockchain, wherein the first blockchain transaction comprises a first hash generated by hashing at least the first journaled message.

26. A computer program embodied on non-transitory computer-readable storage media and configured so as, when run on one or more processors, the one or more processors performs a method of journaling messages sent to and/or from a first party, wherein the method comprises:
determining a first message to be journaled, wherein the first message is sent to or from the first party;
generating a first journaled message, wherein the first journaled message comprises a copy of the first message;
storing the first journaled message and/or an encrypted version of the first journaled message at a storage location;
causing a first blockchain transaction to be sent to a blockchain network to be recorded on a blockchain, wherein the first blockchain transaction comprises a first hash generated by hashing at least the first journaled message.
